(19) United States
(12) Patent Application Publication
(10) Pub. No.: US 2025/0315107 A1
(43) Pub. Date: Oct. 9, 2025

(54) Pressure Measurement and Vibration Feedback System and Method of Operating the Same

(71) Applicant: SHENZHEN SIPO TECHNOLOGY DEVELOPMENT CO., LTD., Shenzhen (CN)

(72) Inventor: Guanhua Chen, Shenzhen (CN)

(21) Appl. No.: 19/243,879

(22) Filed: Jun. 20, 2025

Related U.S. Application Data
(63) Continuation-in-part of application No. PCT/CN2023/125537, filed on Oct. 20, 2023.

(30) Foreign Application Priority Data
Dec. 21, 2022 (CN) 202211652296.6

(51) Int. Cl. G06F 3/01; G06F 3/0354; G06F 3/038

(52) U.S. Cl. CPC G06F 3/016; G06F 3/03547; G06F 3/0383

(57) ABSTRACT

A pressure measurement and vibration feedback system and an operating method for the system are disclosed. The system is arranged with its touch surface facing downward and sequentially includes a cover plate and a PCB board fixed together by a bonding adhesive. A plurality of integrated sensors and a cushioning layer for preventing excessive pressure are provided on the side of the PCB board facing away from the cover plate, the cushioning layer having a relief notch. The integrated sensors are located in the notch area and protrude above the cushioning layer, each sensor having an integrated sensor circuit. The PCB board side facing away from the cover plate is further provided with symmetrically arranged connectors, each connector being electrically connected one-to-one to a corresponding integrated sensor and further connected to a sensing circuit on the PCB board.

### CROSS REFERENCE TO RELATED APPLICATIONS

The present application is a Continuation-In-Part application of PCT Application No. PCT/CN2023/125537 filed on Oct. 20, 2023, which claims priority to Chinese Patent Application No. 202211652296.6, filed on Dec. 21, 2022, entitled “Pressure Measurement and Vibration Feedback System and Method of Operating the Same”, the entire contents of which are hereby incorporated by reference.

### TECHNICAL FIELD

The present disclosure relates to the field of haptic feedback technology, and more particularly to a pressure measurement and vibration feedback system and a method of operating the same.

### BACKGROUND ART

Haptic feedback is a popular technology, and pressure measurement with vibration feedback is a core part of this technology. A pressure-sensitive touchpad uses pressure detection instead of physical buttons to perform operations such as confirmation or menu activation, thereby solving the problem in traditional touchpads where pressing is only effective near physical button locations. A pressure touchpad can adjust the responsiveness to user presses and the vibration feedback intensity according to user preferences, providing a more convenient and comfortable user experience. The quality of the user experience largely depends on the design of the touchpad's structure. Therefore, improvements in pressure touch technology are needed.

### SUMMARY

In view of the deficiencies of the related technology, the technical problem to be solved by the present disclosure is to provide a pressure measurement and vibration feedback system and its operating method, designed for accurate measurement of finger pressure on a touchpad and a wide-range vibration feedback.

To solve the above problem, the present disclosure provides the following solutions:

Pressure Measurement and Vibration Feedback System: The system has its touch surface oriented downward and sequentially includes a cover plate and a PCB board. The cover plate and the PCB board are laminated together and fixed by a bonding glue. The side of the PCB board facing away from the cover plate is provided with a plurality of integrated sensors and a cushioning layer configured to prevent excessive pressure, the cushioning layer having a relief notch. The plurality of integrated sensors are arranged in the relief notch region of the cushioning layer, and the thickness of the cushioning layer is smaller than the thickness of the integrated sensors. Each integrated sensor is equipped with an integrated sensor circuit. The side of the PCB board facing away from the cover plate is further provided with a plurality of symmetrically arranged connectors. The integrated sensors are electrically connected one-to-one to respective connectors, and the connectors are electrically connected to a sensing circuit on the PCB board.

Operating Method for the System: An operating method for the pressure measurement and vibration feedback system is also provided. The method can include the following steps:
1. Sensor Calibration: Upon power-on, the pressure detection and boost control chip automatically calibrates and zeroes the pressure values. The touchpad chip, via a second communication interface, sends the required vibration level FORCE_LEVEL, the detected finger press threshold FORCE_SEN, and the release threshold FORCE_SEN_REL (where FORCE_SEN_REL is less than FORCE_SEN). When no finger is touching the cover plate, the pressure detection and boost control chip performs slow pressure detection via multiple differential voltages of multiple Wheatstone bridge circuits, dynamically calibrating the baseline value of each integrated sensor (4). When a finger touches the cover plate, the touchpad chip (11) uses capacitive scanning and calculation to identify the finger's coordinates and count, reports the coordinates of each finger to the host (10), and sends a signal SIG_TOUCH_ON indicating a finger touch through a communication interface.
2. Pressure Measurement Initialization: After receiving the finger-present signal SIG_TOUCH_ON, the pressure detection and boost control chip (12) switches to fast pressure detection mode. It controls a boost circuit to rapidly raise a drive voltage and then reads pressure values from the integrated sensors (4) via multiple sets of bridge circuits, obtaining the real-time pressure exerted by the finger on each integrated sensor.
3. Sensor Selection: The pressure detection and boost control chip (12) identifies the three integrated sensors experiencing the highest pressures among those under the finger contact area. These three sensors are selected as active sensors for generating a vibration feedback corresponding to the finger press.
4. Vibration Intensity Determination: Using the predetermined vibration level FORCE_LEVEL, the pressure detection and boost control chip (12) determines a target vibration intensity. It maps the measured pressure values to a vibration output level such that a stronger finger press results in a stronger vibration feedback, up to the set maximum vibration level.
5. Vibration Feedback and Output Signal: The touchpad chip (11) receives a Button signal driven low (asserted) by the pressure detection and boost control chip (12) once the press force exceeds the set press threshold FORCE_SEN. The touchpad chip interprets this as a virtual “button” press and reports a corresponding mouse click (e.g. left or right click) to the host. When the finger's pressure falls below the release threshold FORCE_SEN_REL, the pressure detection and boost control chip (12) drives the Button signal high (deasserted), and the touchpad chip (11) reports that the “button” has been released.

Advantageous Effects: The advantageous effects of the present disclosure include at least the following:
Multiple integrated modules for improved feedback: The present disclosure uses multiple integrated pressure-and-vibration modules, a touchpad, a pressure measurement chip, and a boost circuit to achieve precise measurement of finger pressure on the touchpad and a wide-range vibration feedback system. In particular, pressure measurement utilizes an integrated multi-channel pressure sensing approach, allowing pressure data to be captured from multiple points.
Wider pressure detection range: By employing an integrated sensor structure and a dynamic baseline calibration for each sensor, the system can accurately detect varying pressure levels without drift (zero offset) over long-term operation, thus covering a wide pressure range with stability.
Efficient vibration feedback control: The system integrates a flyback-type boost circuit and a PWM (Pulse Width Modulation) switching circuit, which together efficiently generate and control vibration feedback signals. This integration significantly reduces the number of discrete components needed for the vibration driver, leading to a more compact design.
Rapid response and recovery: The pressure measurement chip includes internal resources for boosting control, discharge control, and feedback input. This design ensures rapid boosting and discharging cycles, enabling quick vibration responses to user input and timely recovery (reset) of the system for subsequent operations.
Scalability for multiple sensors: The design of the switching circuit allows multiple integrated sensors to be addressed and driven by a single pressure detection and boost control chip through time-division multiplexing. This means a single controller chip can manage a greater number of sensors without requiring separate drive circuits for each, simplifying the system architecture.
Enhanced user experience: By dynamically adjusting vibration intensity in proportion to detected pressure, the system provides richer haptic feedback. Light presses can trigger gentle feedback while harder presses produce stronger feedback, offering an intuitive and satisfying user experience.
Improved durability: The cushioning layer prevents excessive force from directly impacting the sensors, protecting them from damage due to overpressure. This prolongs the lifespan of the sensors and maintains the accuracy of pressure measurements over time.
Versatility in integration: The pressure measurement and vibration feedback system can be integrated into a variety of touch-input devices (e.g., touchpads, touchscreens) without significant modifications to existing form factors. The modular circuit design (with clearly defined interfaces like I2C communication for multiple chips) makes it easier to incorporate the system into different products.
Broad applicability: The system's design supports reproduction and use in various applications that require precise pressure sensing and haptic feedback. It can be adapted to different industrial or consumer contexts, demonstrating strong industrial applicability (further detailed below).

### BRIEF DESCRIPTION OF THE DRAWINGS

FIG. 1 is an exploded view of a touchpad of the present disclosure having six integrated sensors.

FIG. 2 is an assembled view of the touchpad of FIG. 1.

FIG. 3 is an assembled view of a touchpad of the present disclosure having eight integrated sensors.

FIG. 4 is an overall block diagram of the circuit architecture of the pressure measurement and vibration feedback system according to the present disclosure.

FIG. 5 is a block diagram of various functional modules of the pressure measurement and vibration feedback system's circuitry according to the present disclosure.

FIG. 6 is a circuit diagram of an integrated sensor unit of the present disclosure.

FIG. 7 is a diagram illustrating the relationship between the Ton and Toff intervals of a PWM1 signal in the pressure measurement and vibration feedback system of the present disclosure.

FIG. 8 is a circuit diagram of a common boost circuit in the prior art.

FIG. 9 is a schematic structural diagram showing the interconnection of various circuit modules in the driving circuit of the present disclosure.

FIG. 10 is a circuit diagram of a switching circuit of the present disclosure.

FIG. 11 is a circuit diagram of a PWM switching circuit of the present disclosure.

FIG. 12 is a schematic diagram of a pressure measurement and vibration feedback system of the present disclosure with four sets of integrated sensors.

FIG. 13 is a schematic diagram of a pressure measurement and vibration feedback system of the present disclosure with five sets of integrated sensors.

### REFERENCE NUMERALS IN THE DRAWINGS

1: cover plate; 2: bonding glue; 3: PCB board; 4: integrated sensor; 5: connector; 6: reverse-mounted locking nut; 7: cushioning layer; 8: sensing circuit.
10: host; 11: touchpad chip; 12: pressure detection and boost control chip; 13: I/O expansion chip; 14: driving circuit; 15: integrated sensor circuit; 16: capacitance scanning and finger recognition.
100: boost switching and protection circuit; 101: flyback switching circuit; 102: feedback circuit; 103: discharge circuit; 104: switching circuit; 105: PWM switching circuit.

### DETAILED DESCRIPTION

Hereinafter, the technical solutions of the embodiments of the present disclosure will be described clearly and completely in conjunction with the accompanying drawings, so that the advantages and features of the present disclosure can be readily understood by those skilled in the art, and the scope of the disclosure can be clearly delineated. It should be noted that the described embodiments are exemplary and intended to explain the principles of the disclosure, not to limit its scope.

### Embodiment 1

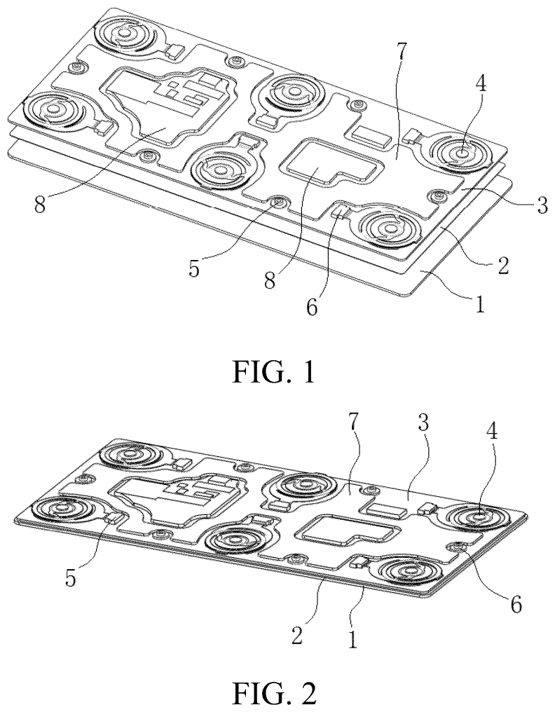

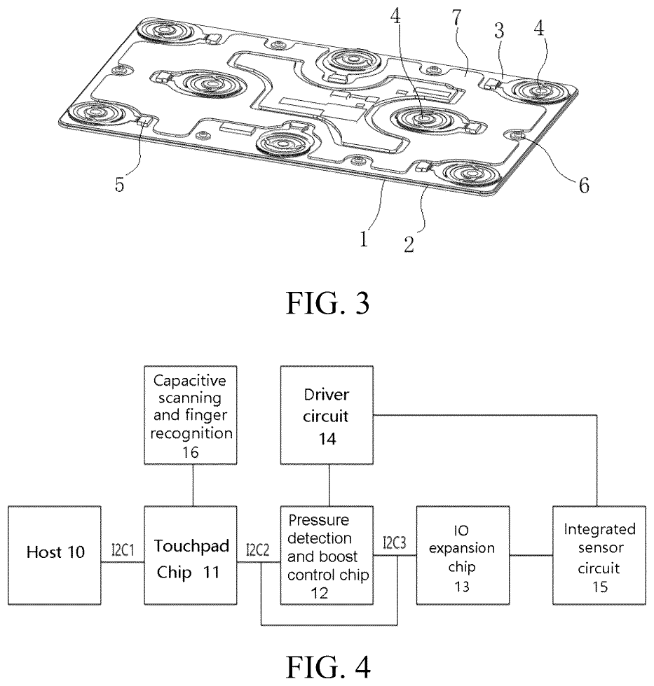

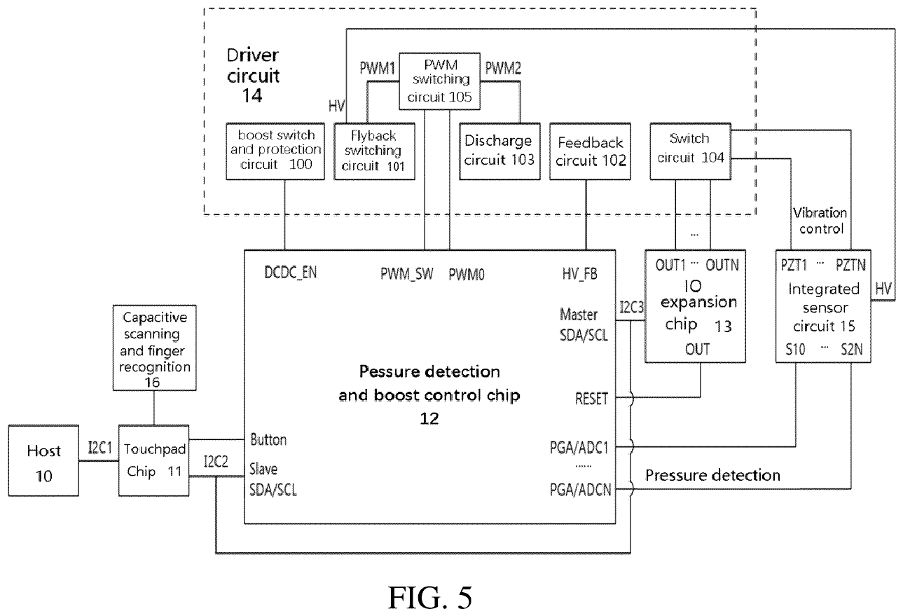

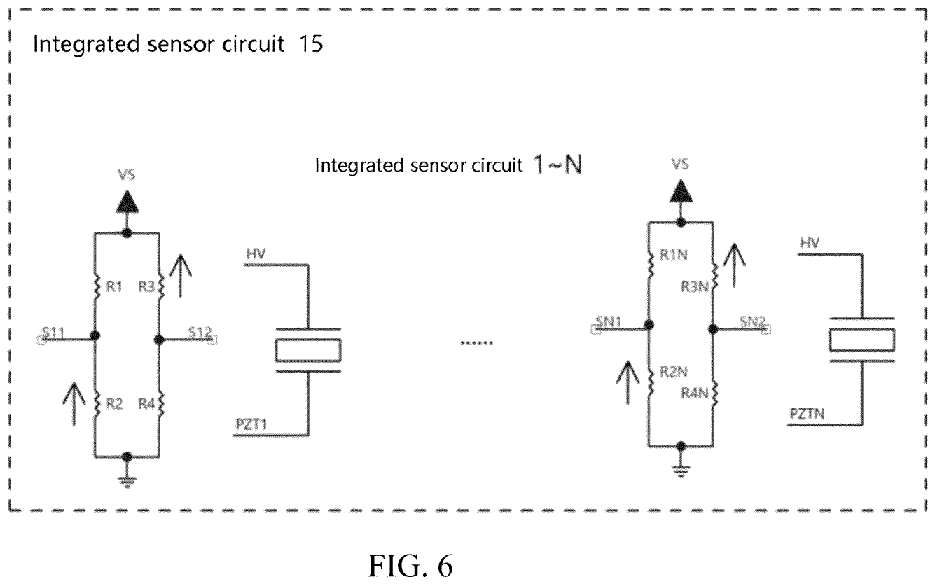

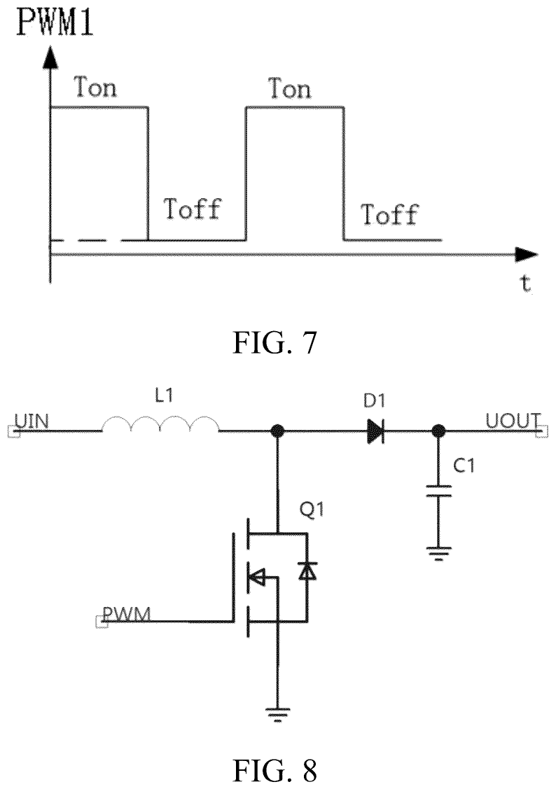

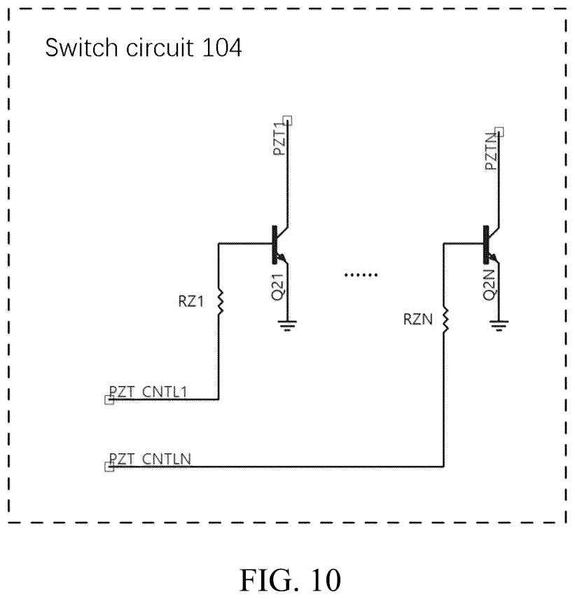

The specific structure of the pressure measurement and vibration feedback system of the present disclosure is as follows: As shown in FIGS. 1 to 11, the system comprises, with the touch surface facing downward, a cover plate (1) and a PCB board (3) arranged in sequence. The cover plate (1) and the PCB board (3) are laminated together and can be fixed by a bonding glue (2). The side of the PCB board (3) facing away from the cover plate (1) may be provided with a number of integrated sensors (4) and a cushioning pad layer (7) to prevent excessive pressure, wherein the cushioning pad layer (7) has a relief notch. The integrated sensors (4) are distributed in the relief notch area of the cushioning layer (7), and the thickness of the cushioning layer (7) is less than the thickness of the integrated sensors (4). Each integrated sensor (4) is equipped with an integrated sensor circuit (15). The side of the PCB board (3) facing away from the cover plate (1) is also provided with a plurality of symmetrically arranged connectors (5). The integrated sensors (4) and the connectors (5) are electrically connected in pairs (one-to-one), and the connectors (5) are electrically connected to a sensing circuit (8) on the PCB board (3). The system utilizes multiple integrated sensors, a touchpad (capacitive) controller, a pressure measurement chip, and a boost circuit to achieve precise finger pressure measurement on the touchpad and a wide-range vibration feedback to the user.

In this embodiment, the touchpad controller chip (11) communicates with the pressure detection and boost control chip (12) and an I/O expansion chip (13) via established communication interfaces. For example, a first communication interface can be used between the touchpad chip (11) and the host (10), a second communication interface between the touchpad chip (11) and the pressure detection and boost control chip (12), and a third communication interface between the touchpad chip (11) and the I/O expansion chip (13). All three communication interfaces are implemented as I²C (Inter-Integrated Circuit) interfaces in this embodiment, ensuring efficient data exchange among the components.

### Embodiment 2

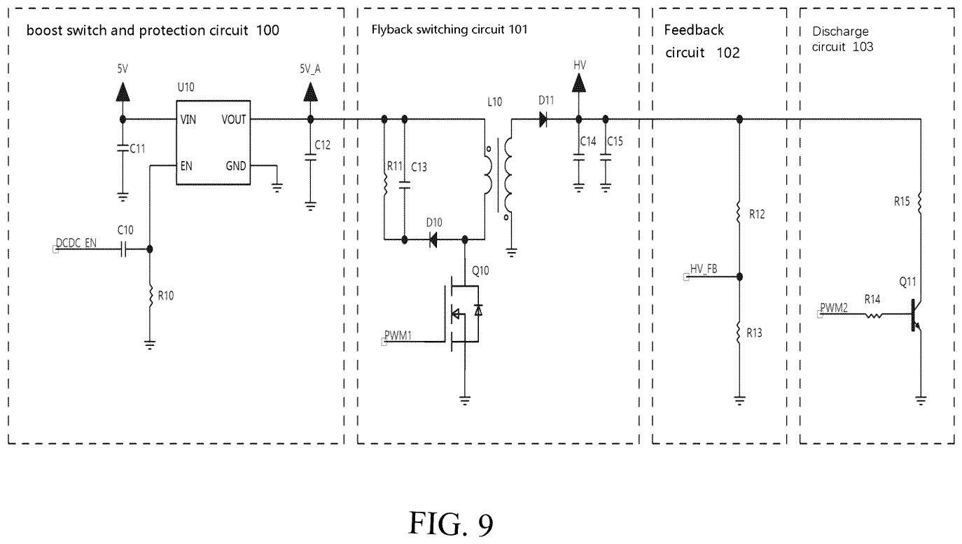

As shown in FIG. 9, in one preferred design of this system, the driving circuit (14) comprises six circuit modules, namely: a boost switching and protection circuit (100), a flyback switching circuit (101), a feedback circuit (102), a discharge circuit (103), a switching circuit (104), and a PWM switching circuit (105). In this embodiment, these modules are interconnected as follows:
The boost switching and protection circuit (100), the feedback circuit (102), the discharge circuit (103), and the PWM switching circuit (105) are each connected to the pressure detection and boost control chip (12).
The flyback switching circuit (101) is connected to the PWM switching circuit (105).
The switching circuit (104) is connected to the I/O expansion chip (13) and to the integrated sensor circuit (15).
An output terminal of the boost switching and protection circuit (100) is connected to an input of the flyback switching circuit (101). An output terminal of the flyback switching circuit (101) is connected to the input of the feedback circuit (102) and to the input of the discharge circuit (103).

Through the above configuration, the driving circuit (14) provides the necessary control and power modulation for the integrated sensors. The boost switching and protection circuit (100) manages the initial power surge (boost) for vibration, while the flyback switching circuit (101) controls the energy transfer (as in a flyback converter). The feedback circuit (102) monitors the output for regulation, and the discharge circuit (103) safely discharges residual energy. The switching circuit (104) distributes signals to the individual sensors via the I/O expansion chip (13) and integrated sensor circuit (15), and the PWM switching circuit (105) routes PWM control signals to appropriate parts of the circuit.

### Embodiment 3

As shown in FIG. 9, in another preferred design, the boost switching and protection circuit (100) is described in detail. The flyback switching circuit (101) in this embodiment includes a transformer L10, a resistor R11, capacitors C13, C14, C15, diodes D10 and D11, and an N-channel MOSFET Q10. The specific connections are as follows: A primary coil of the transformer L10 has one end connected to the output of the boost switching and protection circuit (100), to one end of capacitor C13, and to one end of resistor R11. The other end of the primary coil of transformer L10 is connected to the anode of diode D10 and to the source of N-MOSFET Q10. The cathode of diode D10 is connected to the other end of capacitor C13 and to the other end of resistor R11. The drain of the N-MOS transistor Q10 is grounded, and the gate of N-MOSFET Q10 is connected to the PWM1 output of the PWM switching circuit (105).

The secondary coil of transformer L10 has one end connected to ground. The other end of the secondary coil is connected to the anode of diode D11. The cathode of diode D11 is connected to capacitor C14, to capacitor C15, and to the high-voltage (HV) input of the integrated sensor circuit (15). The other terminals of capacitor C14 and capacitor C15 are each grounded. The cathode of diode D11 is also connected to the feedback circuit (102).

In this way, the flyback switching circuit (101) operates as a flyback converter: when Q10 conducts (controlled by PWM1), energy is stored in transformer L10; when Q10 switches off, the energy is transferred through D11 into the output (charging C14/C15 and supplying the integrated sensor circuit's HV node). Diode D10, resistor R11, and capacitor C13 form a snubber or protection network for the primary side, protecting the circuit from voltage spikes and helping to shape the pulse waveform. The feedback circuit (102) monitors the HV output via the connection at D11's cathode, enabling the pressure detection and boost control chip (12) to regulate the boost voltage appropriately.

### Embodiment 4

In a further preferred design, the feedback circuit (102) is detailed as follows: The feedback circuit (102) includes two resistors R12 and R13 in series. A node between resistor R12 and resistor R13 is connected to the HV_FB feedback pin of the pressure detection and boost control chip (12). One end of resistor R12 is connected to the output of the flyback switching circuit (101) (i.e., the high-voltage output node), and the other end of resistor R12 is connected to resistor R13. The free end of resistor R13 (the end not connected to R12) is connected to ground. In this configuration, resistors R12 and R13 form a voltage divider that feeds back a portion of the high voltage output to the chip (12) for monitoring and regulation. By adjusting the ratio of R12 to R13, the system can set the appropriate feedback voltage level corresponding to the desired output voltage, without requiring an additional voltage follower op-amp circuit, thereby simplifying the design.

### Embodiment 5

In another preferred design, the discharge circuit (103) is described: The discharge circuit (103) includes a resistor R14, an NPN transistor Q11, and a resistor R15. One end of resistor R14 is connected to the base of the NPN transistor Q11. The other end of resistor R14 is connected to a node in the circuit that requires discharge (for example, the high-voltage output node of the flyback circuit). The emitter of the NPN transistor Q11 is grounded, and the base of Q11 is connected via resistor R14 as described. The resistor R15 is connected between the base of Q11 and ground (or between the discharge node and base in a bias configuration, depending on the exact circuit described). In operation, when the pressure detection and boost control chip (12) needs to rapidly discharge the stored energy (for instance, to stop a vibration or reset the system), it can drive the base of Q11 (through R14) allowing current to flow from the high-voltage node through Q11 to ground. Resistor R15 serves as a bias or pull-down to ensure Q11 turns off when discharge is not needed. This discharge circuit quickly bleeds off charge from capacitors (like C14/C15) once the boost event is over, preventing residual vibrations and readying the system for the next operation. This approach provides a simpler discharging path without requiring a dedicated voltage-following operational amplifier, making the circuit more compact.

### Embodiment 6

In a preferred design of the switching circuit (104), the switching circuit (104) is composed of multiple identical switching circuit units. Each switching circuit unit is paired with one of the integrated sensors (4). In other words, the switching circuit (104) contains as many switching sub-circuits as there are integrated sensors, and each sub-circuit controls the connection to a corresponding integrated sensor via the integrated sensor circuit (15).

In one switching circuit unit, an NPN transistor Q2n (where n denotes the index of the unit/sensor) is used as the switching element. The emitter of NPN transistor Q2n is connected to ground. The collector of Q2n is connected to a PZTn electrode (pressure sensing electrode) of the integrated sensor circuit (15). The base of Q2n is connected, through a series resistor RZn, to a control pin PZT_CNTLn of the I/O expansion chip (13). In this configuration, when the I/O expansion chip (13) outputs a control signal on PZT_CNTLn, it drives the base of transistor Q2n (via resistor RZn). If the base is driven high (relative to emitter), Q2n saturates, connecting the integrated sensor's PZTn node to ground (or completing a circuit path, depending on design). By controlling each Q2n, the system can individually activate or deactivate the sensing circuits of each integrated sensor, effectively multiplexing the pressure sensing and vibration driving among multiple sensors using a single control chip (12). The use of multiple switching units paired to sensors allows the system to manage several sensors with one control chipset by time-sharing their operation.

### Embodiment 7

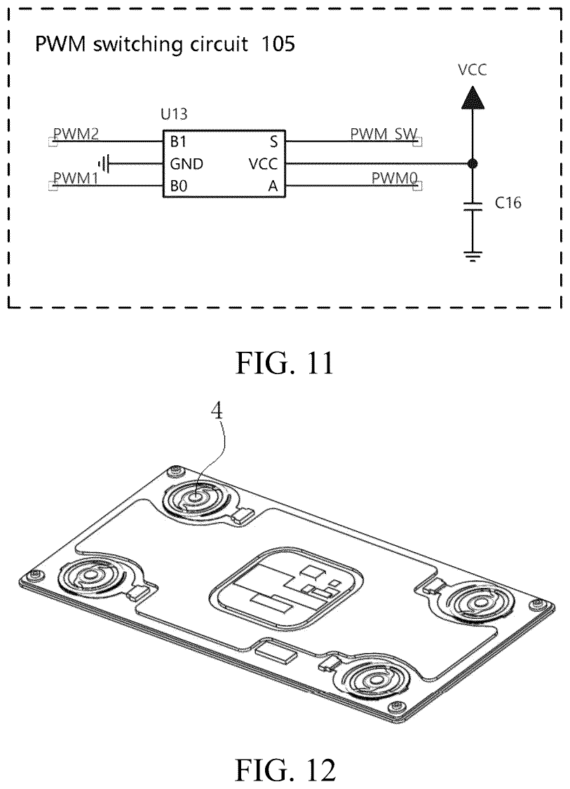

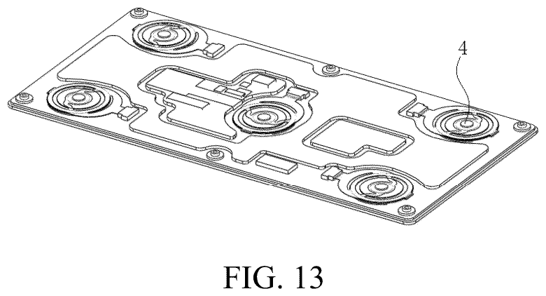

In a preferred design of the PWM switching circuit (105), as shown in FIG. 11, an analog switch chip U13 is incorporated. The analog switch chip U13 has a select input S, a common output/input terminal A, and multiple switched terminals (B0, B1, etc.). In this embodiment, the select pin S of U13 is connected to a PWM_SW control line. The common terminal A of U13 is connected to a primary PWM output (PWM0). The B0 terminal of U13 is connected to a first modulation control line PWM1, and the B1 terminal of U13 is connected to a second modulation control line PWM2. The PWM0 and PWM_SW signals are provided by the pressure detection and boost control chip (12).

When the chip (12) sets the PWM_SW line low (logic 0), the analog switch U13 connects the common terminal A (PWM0) with the B0 terminal (PWM1). Conversely, when the PWM_SW line is high (logic 1), the analog switch U13 connects terminal A (PWM0) with the B1 terminal (PWM2). In essence, the analog switch U13, under the control of PWM_SW, toggles whether the chip's single PWM output (PWM0) is directed to the PWM1 line or the PWM2 line. This hardware configuration allows the pressure detection and boost control chip (12), which may have only one hardware PWM generator (PWM0), to alternate its output between two control lines (PWM1 for boosting and PWM2 for discharging) by using the select signal PWM_SW.

### Embodiment 8

In this embodiment, operational modes of the pressure detection and boost control chip (12) are described for boosting and discharging processes using the PWM switching configuration of Embodiment 7. During a boost phase, the pressure detection and boost control chip (12) sets the PWM_SW control line to a low level. This causes the analog switch U13 to connect PWM0 to the PWM1 line. As a result, the chip's PWM0 output is routed to the PWM1 signal path, which drives the boost circuit (for example, controlling the gate of Q10 in the flyback circuit). During the discharge phase, the pressure detection and boost control chip (12) sets the PWM_SW line to a high level. The analog switch U13 then connects PWM0 to the PWM2 line, routing the PWM output to the discharge control path. By switching PWM_SW, the chip (12) effectively controls whether its PWM output is being used to energize the boost converter or to manage the discharge circuit.

This design means the chip (12) can use a single PWM generator to handle two separate processes (boost and discharge) by time-multiplexing the output. The boost process might use a certain PWM waveform (duty cycle, frequency tuned for charging the vibration actuator), while the discharge process might use a different PWM waveform for a controlled release of energy. The switch U13 ensures that only the intended circuit receives the PWM signal at a time.

### Embodiment 9

This embodiment addresses the calibration of the integrated sensors in manufacturing and during operation. Factory Calibration: Since each integrated sensor (4) uses a printed pressure-sensitive resistor that deforms under pressure, there are inevitable slight differences in the characteristics of each sensor. Additionally, small variances in the placement of each piezoelectric element and the positioning of the thin rubber sheet (cushion) can occur. Therefore, the pressure response of each sensor can differ slightly. To account for this, all integrated sensors undergo an initial calibration to determine their baseline output and sensitivity. The calibration data (offsets, scaling factors) for each sensor are stored (for example, in the chip's memory or an EEPROM). During operation, the pressure detection and boost control chip (12) uses these calibration values to adjust the readings from each sensor, ensuring consistency across all sensors so that the same actual pressure produces uniform readings irrespective of device-to-device variation. This factory calibration greatly improves measurement accuracy and uniformity of the user experience across the touchpad area.

### Embodiment 10

The present disclosure also discloses an operating method for the pressure measurement and vibration feedback system described in Embodiment 1. This method is implemented using the system hardware already described, and proceeds as follows:

Step 1: Sensor Calibration at Startup. When the system is powered on, the pressure detection and boost control chip (12) automatically performs an internal calibration routine. It zeroes the baseline pressure values for all integrated sensors (4) to eliminate any drift or offset. The touchpad controller chip (11) retrieves from memory (or receives from the host or chip 12) the preset vibration level FORCE_LEVEL desired for feedback intensity, the finger press detection threshold FORCE_SEN, and the finger release threshold FORCE_SEN_REL (with FORCE_SEN_REL being lower than FORCE_SEN). If no finger is detected on the cover plate (1), the chip (12) engages in a slow, continuous pressure monitoring mode using multiple differential voltage readings from the sets of Wheatstone bridge circuits connected to the sensors, periodically calibrating each sensor's baseline to account for temperature or environmental changes.

Step 2: Finger Presence Detection and Mode Switching. When a finger touch is detected on the cover plate (1), the touchpad chip (11) through its capacitive sensing mechanism computes the coordinates of the finger and the number of fingers touching. It reports the coordinates of each finger to the host (10) and also sends a signal SIG_TOUCH_ON to notify the pressure detection and boost control chip (12) that a finger is present. Upon receiving the SIG_TOUCH_ON signal, the pressure detection and boost control chip (12) switches from the slow monitoring mode to an active fast detection mode. It activates the boost circuit to prepare for providing haptic feedback and begins reading the pressure values from all integrated sensors (4) at a higher sampling rate.

Step 3: Pressure Reading and Sensor Selection. The pressure detection and boost control chip (12) gathers pressure readings from the integrated sensors (via the Wheatstone bridge circuits) and identifies the sensors under the finger. In particular, it determines the three integrated sensors (4) that are experiencing the greatest pressure (i.e., the highest pressure values) from the finger. These three sensors correspond to the area directly under the finger and its immediate vicinity. By focusing on the top three readings, the system hones in on the main contact area, which helps in calculating the appropriate feedback. These selected sensors' data will be used to compute the feedback output, while other sensors may be ignored or polled less frequently to save processing time.

Step 4: Generating Vibration Feedback Signal. Based on the preset vibration level FORCE_LEVEL and the pressure values from the selected sensors, the pressure detection and boost control chip (12) generates a control signal to drive the vibration actuator(s). Specifically, the chip (12) uses the highest pressure measured (or an average of the top pressures) to determine the strength of the vibration. It then controls the driving circuit (14)—particularly using the PWM switching circuit (105)—to produce a PWM output that, through the boost and flyback circuits, drives the piezoelectric elements of the integrated sensors to vibrate. The result is that when the user presses harder (exceeding FORCE_SEN), a stronger vibration (haptic feedback) is produced. The system is configured such that the vibration intensity is broad, meaning it can produce a range of feedback from very gentle to very strong, depending on the pressure.

Step 5: Outputting “Button” Signal to Host. Simultaneously with generating haptic feedback, the system interprets the finger press as a virtual button press. When the measured pressure crosses the threshold FORCE_SEN (indicating a deliberate press action), the pressure detection and boost control chip (12) pulls a Button signal line to low (active). The touchpad chip (11), which monitors this Button line, detects the low signal and interprets it as a mouse button (or similar input) being pressed. The touchpad chip (11) then reports a corresponding button-down event (e.g., left-click or right-click depending on implementation) to the host (10). The host thus receives an input event as if a physical button were clicked. When the user lifts their finger and the pressure drops below the release threshold FORCE_SEN_REL, the chip (12) releases the Button line (drives it high). The touchpad chip (11) detects the high signal and reports a button release event to the host. This mechanism allows the pressure on the touchpad to fully emulate a traditional clickable button.

Through the above steps, the method provides both a control input (button click) and tactile feedback (vibration) in response to a user's press on the touchpad, enhancing the user experience by confirming actions with physical feedback.

### Embodiment 11

This embodiment covers a continuous press scenario in the operating method. If the user's finger maintains pressure on the touchpad above the set threshold FORCE_SEN for an extended duration, the system responds accordingly. Specifically, when the finger's pressure continuously remains greater than the set pressure value FORCE_SEN, the pressure detection and boost control chip (12) will keep the Button output signal held low (indicating a sustained button-pressed state). Concurrently, the touchpad chip (11) keeps reporting to the host (10) that the “button” is being held down. In this state, the host interprets that the user is not just clicking but holding the button. The system will also ensure that the vibration feedback, if intended to simulate a click, is not repeatedly triggered during the hold (unless a different feedback pattern is desired). Essentially, one vibration is provided upon initial press, and then the button is held without additional vibrations, unless programmed otherwise for a long-press effect. This embodiment ensures that a continuous press is accurately represented in both the input to the host and the haptic feedback (i.e., one strong click vibration at the beginning, then no further vibration while holding).

### Embodiment 12

This embodiment describes an enhanced feedback variation upon release of the press, to distinguish it from the press-down feedback. In some implementations, it is desirable to provide a subtle “release” haptic feedback to the user's finger when they lift off, to mirror the feel of a mechanical button springing back. In this embodiment, the pressure detection and boost control chip (12) is configured to alter the output voltage level used for feedback when a press is released. Specifically, the chip (12) changes the maximum output drive voltage from a first level (HV_VOL1, used for the press-down vibration) to a second level (HV_VOL2) when the finger is lifted. The second level HV_VOL2 is chosen to provide a distinct vibration effect (typically softer or shorter) to signify the release. For example, HV_VOL1 might correspond to a full-strength haptic “click” on press, while HV_VOL2 might be a smaller “tick” vibration on release. By using a different voltage (and thus different vibration intensity or pattern) for the release, the system provides two-stage feedback: a strong confirmation on press and a gentle acknowledgment on release, thereby more closely emulating the feel of a mechanical button which has a tactile response on both press and release.

If the user's finger gradually reduces pressure and falls below the release threshold FORCE_SEN_REL, the chip (12) triggers this release feedback. The PWM switching circuit (105) may direct a short pulse (with amplitude corresponding to HV_VOL2) to the integrated sensor actuators to generate the release vibration. This vibration is distinct from the press vibration, informing the user that the system has registered the end of the press.

### Embodiment 13

This embodiment ensures that the button release condition is properly recognized and the system resets accordingly. When the pressure from the user's finger decreases to below the release threshold FORCE_SEN_REL, the pressure detection and boost control chip (12) will drive the Button output signal high (i.e., deassert the virtual button). The touchpad chip (11) recognizes the rising edge of the Button signal as the button being released and reports a button-up event to the host (10). At this moment, the chip (12) also resets any internal states if necessary and stops any ongoing vibration related to the press. In combination with Embodiment 12, the moment of release (finger lifting) may have triggered a small release vibration; once that is done, the system returns to its baseline monitoring state. If no other fingers are on the touchpad, the system might revert to the slow calibration mode described earlier (updating baseline for any drift). The complete cycle of press and release with corresponding feedback is thus concluded, and the system is ready for the next user interaction.

The above embodiments illustrate the operation of the pressure measurement and vibration feedback system in various scenarios. It should be noted that while certain numbers of sensors, specific values (such as three sensors for feedback, certain thresholds, etc.), or particular components are described, the invention is not limited to these specifics. Variations can be made (for example, using a different number of sensors for feedback, adjusting thresholds, or substituting equivalent circuit elements) without departing from the spirit of the invention.

The foregoing descriptions of embodiments are provided to illustrate the principles and implementations of the present disclosure. These examples should not be interpreted as limiting the scope of the disclosure. Any equivalent structural or process modifications, or any direct or indirect application of the disclosed content in other related technical fields, are intended to be included within the scope of protection of the present disclosure.

### INDUSTRIAL APPLICABILITY

The present disclosure provides a pressure measurement and vibration feedback system and a method for operating the system. The system is constructed with its touch surface facing downward and sequentially includes a cover plate and a PCB board laminated together with bonding glue. The PCB board's side facing away from the cover plate is populated with multiple integrated sensors and a cushioning layer that prevents excessive pressure, with the cushioning layer having a relief notch. A plurality of integrated sensors are arranged within this relief notch of the cushioning layer, and the cushioning layer's thickness is made less than the thickness of the integrated sensors. Each integrated sensor has an integrated sensor circuit. The side of the PCB board facing away from the cover plate is also provided with several symmetrically distributed connectors; each integrated sensor is electrically connected one-to-one with a connector, and the connectors are electrically connected to sensing circuits on the PCB board. The present system utilizes multiple integrated sensors, a touchpad controller, a pressure measurement chip, and a boost circuit to achieve accurate measurement of finger pressure on the touchpad along with a broad-range vibration feedback to the user.

Furthermore, it is understood that the pressure measurement and vibration feedback system of the present disclosure can be readily reproduced and deployed in a variety of industrial applications. For example, the system can be used in any application requiring accurate measurement of finger pressure on a touch interface coupled with haptic (vibration) feedback. This includes, but is not limited to, laptop trackpads, touchscreen panels with force sensing, gaming interfaces, industrial machine controls, or any user interface where replacing physical buttons with a pressure-sensitive surface and providing tactile feedback is advantageous. The invention can be manufactured using standard electronics fabrication processes and integrated into existing devices with minimal modifications. Therefore, the present pressure measurement and vibration feedback system is industrially applicable and can be utilized in a wide range of practical implementations to enhance user interaction experiences.

What is claimed is:

1. A pressure measurement and vibration feedback system, comprising a cover plate and a PCB board arranged sequentially with a touch surface of the system facing downward, the cover plate and the PCB board being laminated together and fixed by a bonding adhesive, wherein: a plurality of integrated sensors and a cushioning layer for preventing excessive pressure are disposed on a side of the PCB board opposite the cover plate, the cushioning layer having a relief notch; the integrated sensors are distributed in an area corresponding to the relief notch of the cushioning layer, with the thickness of the cushioning layer being smaller than the integrated sensors, each integrated sensor having an integrated sensor circuit; and a plurality of symmetrically arranged connectors are provided on the PCB board, each integrated sensor being electrically connected one-to-one to a respective connector, and the connectors being electrically connected to a sensing circuit on the PCB board.

2. The system according to claim 1, wherein communication interfaces among a touchpad chip, a pressure detection and boost control chip, and an I/O expansion chip are I²C interfaces.

3. The system according to claim 1, further comprising a driving circuit including a boost switching and protection circuit, a flyback switching circuit, a feedback circuit, a discharge circuit, a switching circuit, and a PWM switching circuit, wherein: the boost switching and protection circuit, feedback circuit, discharge circuit, and PWM switching circuit are connected to the pressure detection and boost control chip; the flyback switching circuit is connected to the PWM switching circuit; the switching circuit is connected to the I/O expansion chip and integrated sensor circuit; the boost switching and protection circuit output is connected to the flyback switching circuit, and the flyback switching circuit outputs are respectively connected to the feedback circuit and discharge circuit.

4. The system according to claim 3, wherein the boost switching and protection circuit comprises a load switch chip, capacitors, and resistors configured to limit inrush current.

5. The system according to claim 3, wherein the flyback switching circuit comprises a transformer, an N-channel MOSFET, diodes, capacitors, and resistors, configured to generate a boosted voltage for the integrated sensors.

6. The system according to claim 3, wherein the feedback circuit comprises a voltage divider formed by series resistors connected to a feedback input of the pressure detection and boost control chip.

7. The system according to claim 3, wherein the discharge circuit comprises an NPN transistor and resistors configured to discharge stored energy rapidly.

8. The system according to claim 3, wherein the switching circuit includes multiple identical switching units, each unit paired with one integrated sensor.

9. The system according to claim 8, wherein each switching unit comprises an NPN transistor whose base is connected through a resistor to the I/O expansion chip, and whose collector connects to an electrode of an integrated sensor circuit.

10. The system according to claim 3, wherein the PWM switching circuit includes an analog switch chip configured to route PWM signals from the pressure detection and boost control chip to different circuit paths for boosting and discharging.

11. The system according to claim 10, wherein the pressure detection and boost control chip selects the boosting or discharging path by toggling a PWM_SW control signal.

12. A method for operating the pressure measurement and vibration feedback system according to claim 1, comprising: calibrating and zeroing baseline pressure values upon system power-up; monitoring pressure slowly when no finger is detected on the cover plate, using multiple differential voltage readings; rapidly sampling pressure values when a finger touch is detected, identifying sensors under the finger contact area; determining vibration feedback based on measured pressure and predefined vibration levels; outputting vibration feedback signals via a PWM switching circuit to drive integrated sensors acting as actuators.

13. The method according to claim 12, wherein the finger touch and release actions generate distinct vibration feedback signals.

14. The method according to claim 12, wherein the pressure detection and boost control chip maintains a virtual button press signal when finger pressure exceeds a preset threshold continuously.

15. The method according to claim 12, wherein the release of finger pressure below a threshold triggers a distinct release vibration effect.

16. The method according to claim 12, further comprising dynamically recalibrating sensor baselines when finger pressure is not detected.

17. The method according to claim 12, wherein the PWM switching circuit allows time-division multiplexing of a single PWM output to handle boosting and discharging processes.

18. The method according to claim 12, wherein sensor selection for vibration feedback is based on the highest pressure values detected by integrated sensors.

19. The method according to claim 12, further comprising a factory calibration step for determining baseline outputs and sensitivity adjustments for each integrated sensor.

20. The method according to claim 12, wherein vibration intensity varies proportionally with the detected finger pressure.
